(19) United States
(12) Patent Application Publication
(10) Pub. No.: US 2014/0047256 A1
(43) Pub. Date: Feb. 13, 2014

(54) TERMINAL DEVICE AND METHOD FOR OPERATING THE SAME

(71) Applicant: Dan Hua LI, Shenzhen (CN)

(72) Inventor: Dan Hua LI, Shenzhen (CN)

(73) Assignee: Tencent Technology (Shenzhen) Co., Ltd., Shenzhen (CN)

(21) Appl. No.: 14/052,546

(22) Filed: Oct. 11, 2013

Related U.S. Application Data
(63) Continuation of application No. PCT/CN2013/079477, filed on Jul. 16, 2013.

(30) Foreign Application Priority Data
Jul. 17, 2012 (CN) 201210247282.6

(51) Int. Cl. G06F 1/32

(52) U.S. Cl. CPC G06F 1/3287
USPC 713/323

(57) ABSTRACT

The present disclosure discloses terminal devices and a method of operating the same, and relates to the field of terminal technology. The method includes: obtaining a current load occupancy parameter of a terminal device; and adjusting a working parameter of the terminal device's processing unit based on the current load occupancy parameter of the terminal device. The present disclosure can estimate the actual occupancy of a terminal device based on the load occupancy parameter of the terminal device, and can adjust a working parameter of the processing unit in real-time based on the load occupancy parameter, thereby controlling and reducing power usage from the bottom layer of the terminal device. In contrast to existing technologies, the disclosure does not require stopping certain services on the terminal device to achieve the goal of saving power, and power can be saved without affecting the normal operations of the terminal device.

### CROSS REFERENCE TO RELATED APPLICATION

This application is a U.S. continuation application under 35 U.S.C. §111(a) claiming priority under 35 U.S.C. §§120 and 365(c) to International Application No. PCT/CN2013/079477 filed Jul. 16, 2013, which claims the priority benefit of Chinese Patent Application No. 201210247282.6 filed Jul. 17, 2012, the contents of which are incorporated by reference herein in their entirety for all intended purposes.

### FIELD

The present disclosure relates to terminal technologies, and in particular, to a method of operating a terminal device and a terminal device.

### BACKGROUND

With the development of terminal devices, there are more and more programs that can be executed and operations that can be carried out on terminal devices. However, because the amount of power that can be stored in a terminal device, in particular, a mobile terminal, is limited, executing more programs and carrying out more operations translate into higher power consumption, which significantly reduces the standby time of the terminal device, affecting its normal use by its user. Therefore, the existing technologies came up with a method of operating terminal devices that achieve the purpose of saving power by stopping certain services on terminal device.

During the realization of the present invention, the inventor has discovered that the existing technologies have at least the following defects:

The normal operation of a terminal device may be affected when certain services on the terminal device are stopped. The functions provide by the terminal device may be greatly limited after the device enters a power-saving mode, and the power saving effect is insignificant.

### SUMMARY

To resolve the shortcoming of the existing technologies, embodiments of the present disclosure provides a method for operating a terminal device and a terminal device. The technical solutions are as follows.

In a first aspect, the disclosure relates to a method of operating a terminal device, including obtaining a current load occupancy parameter of the terminal device, and adjusting a working parameter of a processing unit of the terminal device in accordance with the current load occupancy parameter of the terminal device.

In another aspect, the disclosure relates to a terminal device including: a load occupancy parameter obtaining module that obtains the terminal device's current load occupancy parameter, and an adjusting module that adjusts a working parameter of the terminal device's processing unit according to the current load occupancy parameter of the terminal device.

The present embodiment can provide a method of operating terminal devices, which can obtain the current load occupancy parameter of a terminal device and adjust the working parameters of the terminal device's processing unit(s) based on the current load occupancy parameter of the terminal device. Using the technical schemes provided by the present disclosure, the actual occupancy of a terminal device can be estimated based on the load occupancy parameter of the terminal device. The working parameters of the processing units can be adjusted in real-time based on the load occupancy parameter, thereby controlling and saving power from the bottom layer of the terminal device. In contrast to existing technologies, there is no need to stop certain services on a terminal device to achieve the goal of saving power, and normal operations of the terminal device do not have to be affected.

### BRIEF DESCRIPTION OF THE DRAWINGS

To better explain the technical solutions in the embodiments of the disclosure, the figures discussed in the following embodiments are briefly introduced. It should be understood that the figures described below correspond to only some of the embodiments and that other figures can be derived from these figures.

FIG. 1 is a flowchart illustrating the exemplary steps in a method of operating a terminal device, according to an embodiment of the disclosure.

FIG. 2 is a block diagram illustrating the exemplary modules of a terminal device, according to another embodiment of the disclosure.

FIG. 3 illustrates exemplary common components of a computing system such as a device in the various embodiments described below.

FIG. 4 is a block diagram illustrating an exemplary API architecture, which may be used in some embodiments of the disclosure.

### DETAILED DESCRIPTION

A detailed description of the technical solutions of the embodiments of the present disclosure is provided below in view of the accompanying drawings. It should be understood that the embodiments described below are representative embodiments of the present disclosure rather than a complete disclosure of the every possible embodiment. The present disclosure can also include any other embodiments that can be derived from these disclosed embodiments by a person with ordinary skill in the art without any additional inventive work. It is to be understood that other embodiments can be used and structural changes can be made without departing from the scope of the embodiments of this disclosure.

In general, this relates to power conservation technology for an electric device. In particular, embodiments of the disclosure can determine a load occupancy parameter of the device and, in turn, manage power consumption based on the load occupancy parameter.

More specifically, a load occupancy parameter can be determined based on an operating mode of the device. Exemplary modes can include a game mode, reading mode, sleep mode, etc. Each mode can be defined by the one or more applications and/or processes active on the device at the time. For example, in the game mode, a gaming application can be running on the device. In addition, input/output (I/O), sound, and/or graphics processes associated with running the gaming application can also be relevant with regard to defining the game mode. Alternatively, a load occupancy parameter can be determined based on one or more usage activities, such as web-browsing, locking the screen of the device, charging the device, etc. The activities may or may not be associated with the applications on the device. In some embodiment, the correspondence between the operating modes and the load occupancy parameters and/or the correspondence between the usage activities and the load occupancy parameters can be predetermined either automatically by the device or set manually in response to user input and stored as reference in a storage medium (e.g., memory) of the device. This allows the device to determine a load occupancy parameter when it detects the device to be in one of the defined modes or performing one or more of the known usage activities by looking up the stored correspondence from the storage medium.

For each load occupancy parameter, a corresponding power requirement can be determined. In particular, the device can automatically adjust the voltage or frequency requirements for one or more of the processors in the device based on the load occupancy parameter. The adjustment to the processing units' working parameters can be achieved through, for example, calling an API (Application Programming Interface). For example, a load occupancy parameter corresponding to a screen-locking activity can prompt the device to reduce power output because a minimum number of processes may be active when the screen of the device is locked. Thus, embodiments of the disclosure allow the device to automatically adjust the power output based on the state of the device without requiring much user input. In fact, in one embodiment, the disclosed power saving feature can be turned on by a single-key input from the user and remain active without further user input.

A more detailed description of the embodiment is provided below in view of the attached to clarify the purpose, technical scheme, and advantages of the present disclosure.

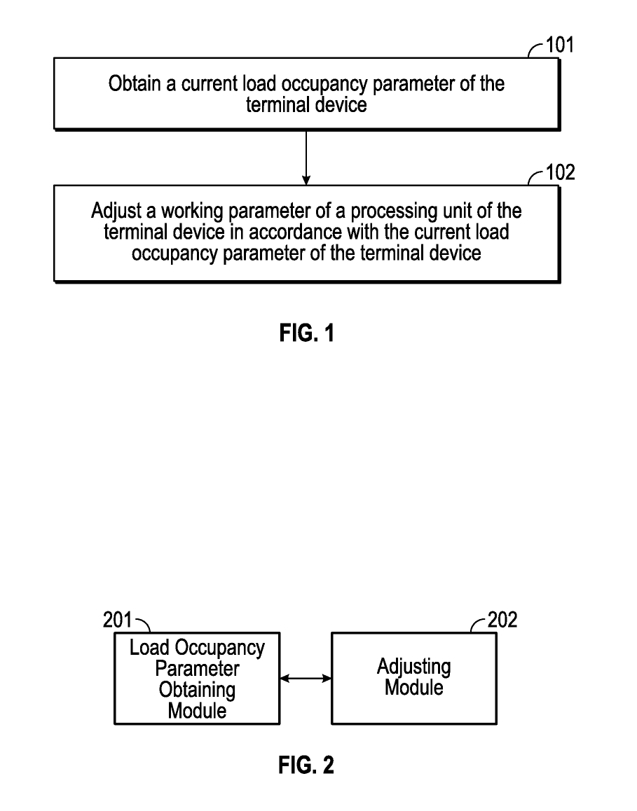

FIG. 1 is a schematic diagram illustrating a method of operating a terminal device, according to an embodiment of the present invention. The method can be performed by the terminal device, which is a mobile terminal or stationary terminal, and the mobile terminal may be a smart phone, a tablet, an MP3 (Moving Picture Experts Group Audio Layer III) device, a PDA (Personal Digital Assistant), or other suitable devices. As illustrated by FIG. 1, the method of operating terminal device can include, for example:

101. Obtaining the current load occupancy parameter of a terminal device.

The load occupancy parameter in the present embodiment can be used to indicate the utilization status of the terminal device, and may be set by a technician according to the operating mode and the usage activities associated with the terminal device. Different operating modes or activities can correspond to different values of the load occupancy parameter.

The obtaining process can be triggered by a terminal device user using a single-key activation of the power-saving mode of the hardware. All the subsequent particular adjustments can be carried out in the background of the terminal device without affecting the foreground display, thus providing the terminal device user with an optimized adjusting mode.

102. Adjusting at least one working parameter of the terminal device's processing unit based on the current load occupancy parameter of the terminal device.

The processing unit can include a CPU (Central Processing Unit) and/or a GPU (Graphic Processing Unit). The at least one working parameter can include, for example, a working frequency and/or working voltage. The adjustments involved in the present embodiment can be adjustments of the working frequency and/or working voltage of the CPU, adjustments of the working frequency and/or working voltage of the GPU, or adjustments of the working frequencies and/or working voltages of both the CPU and the GPU. A CPU is the computing and controlling core of a computer. Its main function can include interpreting computer commands and processing data in computer software. A GPU can be a concept in contrast to the CPU. The GPU can be a core processor specifically for graphics.

In the present embodiment, after the current load occupancy parameter of the terminal device is determined, the working frequency and/or working voltage corresponding to the current load occupancy parameter can be determined in accordance with a set correspondence between the load occupancy parameter and working frequencies and/or working voltages. Adjustments can be carried out based on the corresponding working frequency and/or working voltage to make the terminal device run under the corresponding working frequency and/or working voltage.

The present embodiment can provide a method of operating terminal devices, which can obtain the current load occupancy parameter of a terminal device and adjust the working parameters of the terminal device's processing unit(s) based on the current load occupancy parameter of the terminal device. Using the technical schemes provided by the present disclosure, the actual occupancy of a terminal device can be estimated based on the load occupancy parameter of the terminal device. The working parameters of the processing units can be adjusted in real-time based on the load occupancy parameter, thereby controlling and saving power from the bottom layer of the terminal device. In contrast to existing technologies, there is no need to stop certain services on a terminal device to achieve the goal of saving power, and normal operations of the terminal device do not have to be affected.

Optionally, on the basis of the embodiment illustrated in FIG. 1, step 101 “obtaining the current load occupancy parameter of a terminal device” can include at least one of the following steps (1) and (2).

(1) Based on the terminal device's operating mode, obtaining the load occupancy parameter corresponding to the operating mode in accordance with a set correspondence between operating modes and load occupancy parameters.

The operating mode in this embodiment can refer to the state of the terminal device is in, such as a game mode, reading mode, sleep mode, etc. Different operating modes can correspond to different load occupancy parameters or the same load occupancy parameter.

In the present embodiment, the set correspondence between operating modes and load occupancy parameters can be set by a technician or user according to the load occupancy of each different operating mode. The correspondence may be different for terminal devices from different manufacturers.

(2) Based on the usage activity on the terminal device, obtaining the load occupancy parameter corresponding to the usage activity based on the set correspondence between usage activities and load occupancy parameters.

The usage activity in the present embodiment can refer to the user's operations on the terminal device, such as locking the screen, charging power, running a game, browsing webpages, etc. Different usage activities can correspond to the same or different load occupancy parameters.

In the present embodiment, the set correspondence between usage activities and load occupancy parameters can be set by a technician or user according to the load occupancy of each different operating mode and may be different for terminal devices from different manufacturers.

The above embodiment only describes step 101 including either step (1) or (2). In addition, step 101 “obtaining the current load occupancy parameter of a terminal device” can include both steps (1) and (2). That is, the operating mode of the terminal device and the usage activity on the terminal device are both considered when obtaining the load occupancy parameter. At this time, step 101 can include: based on the terminal device's operating mode, obtaining the load occupancy parameter corresponding to the operating mode based on the set correspondence between operating modes and load occupancy parameters; based on the usage activity associated with the terminal device, obtaining the load occupancy parameter corresponding to the usage activity based on the set correspondence between usage activities and load occupancy parameters; and selecting the higher load occupancy parameter between the load occupancy parameter corresponding to the operating mode and the load occupancy parameter corresponding to the usage activity as the terminal device's current load occupancy parameter. Selecting the higher load occupancy parameter as the terminal device's current load occupancy parameter by comparing the two parameters can ensure thon the terminal device's normal operations are not affected.

The present embodiment can provide a method of operating a terminal device, which obtains the current load occupancy parameter of the terminal device; and adjusts the at least one working parameter of the terminal device's processing unit(s) based on the current load occupancy parameter of the terminal device. Using the technical scheme provided by the present disclosure, the actual occupancy of a terminal device can be estimated based on the load occupancy parameter of the terminal device. The at least one working parameter of the processing unit(s) can be adjusted in real-time based on the load occupancy parameter, thereby controlling and saving power from the bottom layer of the terminal device. In contrast to existing technologies, there is no need to stop certain services on the terminal device to achieve the goal of saving power, and power can be saved without affecting normal operations of the terminal device. Further, based on the state in which the terminal device is used (e.g., operating mode and/or usage activity, the current load occupancy parameter of the terminal device can be determined to enable the user to adjust the working voltage and/or working frequency according to the user-defined state and to relate the state to the operations of the processing unit(s) to assure the operating of the terminal device while saving power.

Alternatively, on the basis of the embodiment illustrated in FIG. 1, step (1) “based on the terminal device's operating mode, obtaining the load occupancy parameter corresponding to the operating mode based on the set correspondence between operating modes and load occupancy parameters” can include at least one of (a), (b) and (c) below.

(a) When the operating mode is a game mode, obtaining a first load occupancy parameter corresponding to the game mode based on the set correspondence between the operating modes and load occupancy parameters.

(b) When the operating mode is a reading mode, obtaining a second load occupancy parameter corresponding to the reading mode based on the set correspondence between the operating modes and load occupancy parameters.

(c) When the operating mode is a sleep mode, obtaining the third load occupancy parameter corresponding to the sleep mode based on the set correspondence between the operating modes and load occupancy parameters.

In the above three steps, the first load occupancy parameter can be higher than the second load occupancy parameter, which can be higher than the third load occupancy parameter.

The above steps (a), (b) and (c) are described below in conjunction with the respective specific states.

The different operating modes of a terminal device can correspond to different load occupancy parameters, and the correspondence between the operating modes and load occupancy parameters can be obtained through the detection of different operating modes and then saved, or be set manually by a technician or user to avoid repeating the process of detecting the current operating mode for obtaining load occupancy parameter. When it is detected thon the terminal device is currently in a game mode, the present embodiment may not limit the value of the load occupancy parameter because the game mode can require high load occupancy and the corresponding load occupancy parameter can also be high. It can be obtained, by comparing the game mode, reading mode, and sleep mode, that the actual load occupancy of game mode is higher than that of the reading mode, and the actual load occupancy of the reading mode can be higher than that of sleep mode. When the set correspondence between operating modes and load occupancy parameters is set, the first load occupancy parameter may be set to be higher than the second load occupancy parameter, and the second load occupancy parameter may be set to be higher than the third load occupancy parameter to differentiate the load occupancies associated with the different modes.

Alternatively, based on the embodiment illustrated in FIG. 1, step (2), “based on the usage activity associated with the terminal device, obtaining the load occupancy parameter corresponding to the usage activity based on the set correspondence between usage activities and load occupancy parameters” can include at least one of (d), (e), (f) and (g) below.

(d) When the usage activity is running a game on the terminal device, obtaining a fourth load occupancy parameter corresponding to game running in accordance with the set correspondence between usage activities and load occupancy parameters.

(e) When the usage activity is webpage browsing, obtaining a fifth load occupancy parameter corresponding to the webpage browsing in accordance with the set correspondence between usage activities and load occupancy parameters.

(f) When the usage activity is screen locking, obtaining a sixth load occupancy parameter corresponding to screen locking in accordance with the set correspondence between usage activities and load occupancy parameters.

(g) When the usage activity is power charging, obtaining a seventh load occupancy parameter corresponding to the power charging in accordance with the set correspondence between usage activities and load occupancy parameters.

In the above steps, the fourth load occupancy parameter can be higher than the fifth load occupancy parameter, sixth load occupancy parameter, and seventh load occupancy parameter.

The above (d), (e), (f) and (g) are described below in conjunction with their respective states.

Different usage activities associated with a terminal device can correspond to different load occupancy parameters, and the correspondence between the operating usage activities and load occupancy parameters can be obtained through detecting different usage activities and then saved, or be set manually by a technician or user to avoid repeating the process of detecting the current usage activity for obtaining the load occupancy parameter. When it is detected that the current usage activity associated with the terminal device is running a game, the present embodiment may not limit the value of the load occupancy parameter because the activity can require high load occupancy and the corresponding load occupancy parameter can be high. It should be noted that running a game, as a usage activity, and the game mode, as an operating mode, may be set to have the same load occupancy parameter or different load occupancy parameters. It can be ascertained, by comparing screen locking, power charging, game running, and webpage browsing, that the actual load occupancy of game running is higher than those of screen locking, power charging, and webpage browsing. When setting of the set correspondence between the operating modes and load occupancy parameters, one can set the fourth load occupancy parameter to be higher than the fifth, sixth, and, seventh load occupancy parameters to differentiate the load occupancies of different usage activity. The order of the fifth, sixth and seventh load occupancy parameters are not defined in the present embodiment, and the particular order can be set according to actual detections.

Alternatively, based on the embodiment illustrated in FIG. 1, step 102, “adjusting the working parameters of the terminal device's processing units based on the current load occupancy parameter of the terminal device” can include:

(h) When the current load occupancy parameter of the terminal device is within the first range of values, setting the working parameter of the terminal device's processing unit(s) to be the first frequency and/or the first voltage.

(i) When the current load occupancy parameter of the terminal device is within the second range of values, setting the working parameter of the terminal device's processing unit(s) to be the second frequency and/or the second voltage.

(j) When the current load occupancy parameter of the terminal device is within the third range of values, setting the working parameter of the terminal device's processing unit(s) to be the third frequency and/or the third voltage.

In the above steps, the values in the first range of values can be lower than those in the second, and the values in the second range can be lower than those in the third.

The first frequency can be lower than the second, and the second frequency can be lower than the third.

The first voltage can be lower than the second, and the second can be lower than the third.

The above (h), (i) and (j) are described below in conjunction with their respective states:

In the present embodiment, load occupancy parameter can be divided into three ranges of values, e.g., a first range of values, second range of values, and third range of values. Preferably, the first range of value can be [0, 30%], the second range can be [30%, 70%], and the third range can be [70%, 100%]. After the range of values corresponding to the load occupancy parameter is determined, the working frequency and/or working parameter of the processing unit(s) can be adjusted according to the range of values. To facilitate adjustment, the correspondence between the range of values and working frequencies/voltages can be set on the terminal device. Alternatively, the terminal device can obtain the correspondence over a network. The corresponding working frequency and/or working voltage can be obtained according to the determined range of values. The current working frequency and/or working voltage of the terminal device can then be adjusted to the determined working frequency and/or working voltage. Generally, in the state of low occupancy (the first range of values), the current working frequencies and/or working voltages of the processing unit(s) of the terminal device can be reduced to the first frequency and/or first voltage to save power. In the scenario of medium occupancy (the second range of values), the frequencies and voltages of the CPU and the GPU can be dynamically adjusted according to the current working frequencies and/or working voltages of the processing unit(s) of the terminal device. Specifically, when the current working frequencies and/or working voltages of the processing unit(s) of the terminal device are higher than the working frequencies and/or working voltages corresponding to the second range of values, the working frequencies and/or working voltages of the terminal device's processing unit(s) can be reduced to the second frequency and/or second voltage corresponding to the second range of values. When the working frequencies and/or working voltages of the terminal device's processing unit(s) are higher than the working frequencies and/or working voltages corresponding to the second range of values, no adjustment may need to be made. In the state of high occupancy (the third range of values), the working frequencies and/or working voltages of the terminal device's processing unit(s) can be adjusted to the third frequency and/or the third voltage. Alternatively, the processing units can be kept at full load and even higher working frequencies and/or working voltages to assure a more fluent operating experience. It should be noted that the current working frequencies and/or working voltages of a terminal device's processing unit(s) may be obtained by scanning the hardware of the terminal device when step 101 is triggered. In addition, the processing unit(s) of a terminal device may have various kinds of working frequencies and/or working voltages. Each of the first, the second and the third working frequencies and/or working voltages described in the present disclosure may be one group of the terminal device's inherent frequencies or voltages, or parameters beyond the inherent frequencies or voltages set by a technician. Further, the adjustment to the processing units' working parameters can be achieved through calling an API of the terminal device. The APIs with the function in different terminal devices can have different names.

FIG. 2 is a structural diagram of an exemplary terminal device, according to an embodiment of the present disclosure. As shown by FIG. 2, it can include:

A load occupancy parameter obtaining module 201, which can be used for obtaining the terminal device's current load occupancy parameter.

An adjusting module 202, which can be used for adjusting the working parameter(s) of the terminal device's processing unit(s) according to the current load occupancy parameter of the terminal device.

Alternatively, the load occupancy parameter obtaining module 201 can be used for obtaining, according to the terminal device's operating mode, a load occupancy parameter corresponding to the operating mode in accordance with a set correspondence between operating modes and load occupancy parameters.

Additionally or alternatively, the load occupancy parameter obtaining module 201 can be used for obtaining, according to the usage activity associated with the terminal device, the load occupancy parameter corresponding to the usage activity in accordance with a set correspondence between usage activities and load occupancy parameters.

Alternatively, the load occupancy parameter obtaining module 201 can be used for at least one of the following:

When the operating mode is a game mode, obtaining a first load occupancy parameter corresponding to the game mode in accordance with the set correspondence between operating modes and load occupancy parameters.

When the operating mode is a reading mode, obtaining a second load occupancy parameter corresponding to the reading mode in accordance with the set correspondence between operating modes and load occupancy parameters.

When the operating mode is a sleep mode, obtaining the third load occupancy parameter corresponding to the sleep mode in accordance with the set correspondence between operating modes and load occupancy parameters.

The first load occupancy parameter can be higher than the second load occupancy parameter, and the second load occupancy parameter can be higher than the third load occupancy parameter.

Alternatively, the load occupancy parameter obtaining module can be used for at least one of the following.

When a game is running on the terminal device, obtaining a fourth load occupancy parameter corresponding to game running in accordance with the set correspondence between usage activities and load occupancy parameters.

When the usage activity is webpage browsing, obtaining a fifth load occupancy parameter corresponding to webpage browsing in accordance with the set correspondence between usage activities and load occupancy parameters.

When the usage activity is screen locking, obtaining a sixth load occupancy parameter corresponding to screen locking in accordance with the set correspondence between usage activities and load occupancy parameters.

When the usage activity is power charging, obtaining a seventh load occupancy parameter corresponding to power charging in accordance with the set correspondence between usage activities and load occupancy parameters.

The fourth load occupancy parameter is higher than the fifth, and the sixth load occupancy parameter is higher than the seventh.

Alternatively, the adjusting module 202 can be used for adjusting, when the current load occupancy parameter of the terminal device is within the first range of values, a working parameter of the terminal device's processing unit to be the first frequency and/or the first voltage.

When the current load occupancy parameter of the terminal device is within the second range of values, adjusting the working parameter of the terminal device's processing unit to be the second frequency and/or the second voltage.

When the current load occupancy parameter of the terminal device is within the third range of values, adjusting the working parameter of the terminal device's processing unit to be the third frequency and/or the third voltage.

The values in the first range of values can be lower than those in the second, and the values in the second range of values can be lower than those in the third.

The first frequency can be lower than the second, and the second frequency can be lower than the third.

The first voltage can be lower than the second, and the second can be lower than the third.

Alternatively, the processing unit can include a CPU and/or GPU.

The embodiments of the present disclosure can provide a terminal device, which can obtain the current load occupancy parameter of a terminal device; and adjust a working parameter of the terminal device's processing unit in accordance with the current load occupancy parameter of the terminal device. Using the technical scheme provided by the present disclosure, one can estimate the actual occupancy of a terminal device in accordance with the load occupancy parameter of the terminal device, and can adjust the working parameter of the processing unit in real-time in accordance with the load occupancy parameter, thereby controlling and saving power from the bottom layer of the terminal device. In contrast to existing technologies, one does not have to stop certain services on the terminal device to achieve the goal of saving power, and power can be saved without affecting normal operations of the terminal device.

It should be noted that the method of operating a terminal device provided by the above embodiments are introduced and illustrated based on the classification of the functional modules described above. In practice, the functions described above can be assigned to be achieved by different functional modules according to actual needs, which can be facilitated by re-organizing the inner structures of a device into different functional modules so as to achieve all or part of the functions described above. Further, the terminal devices and the methods provided by the above embodiments can be of the same concept. The particular process of realization can be as illustrated by the embodiments of the method.

Ordinary technical professionals in this field can understand that all or part of the steps in the above embodiment can be achieved by hardware or by programs instructing relevant hardware; the programs may be stored in a computer-readable storage medium, and the storage medium may be read-only memory, magnetic disk or optical disk.

The above description presents only a relatively preferred embodiment of the present invention, and does not mean to restrict this invention. Any modification, equivalent replacement, improvement made on the basis of the spirit and principle of the present invention shall be included in the scope of protection for the present invention.

In accordance with the above-described embodiments, a person skilled in the art can understand that parts of or the whole process described in each of the above embodiments can be performed by hardware in accordance with instructions from one or more computer programs. The one or more computer programs can be stored in a non-transitory readable medium, which can be read-only memory (ROM), a floppy disk, or a CD.

In some embodiments, one or more of the modules in FIG. 2 can be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this file, a “non-transitory computer-readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

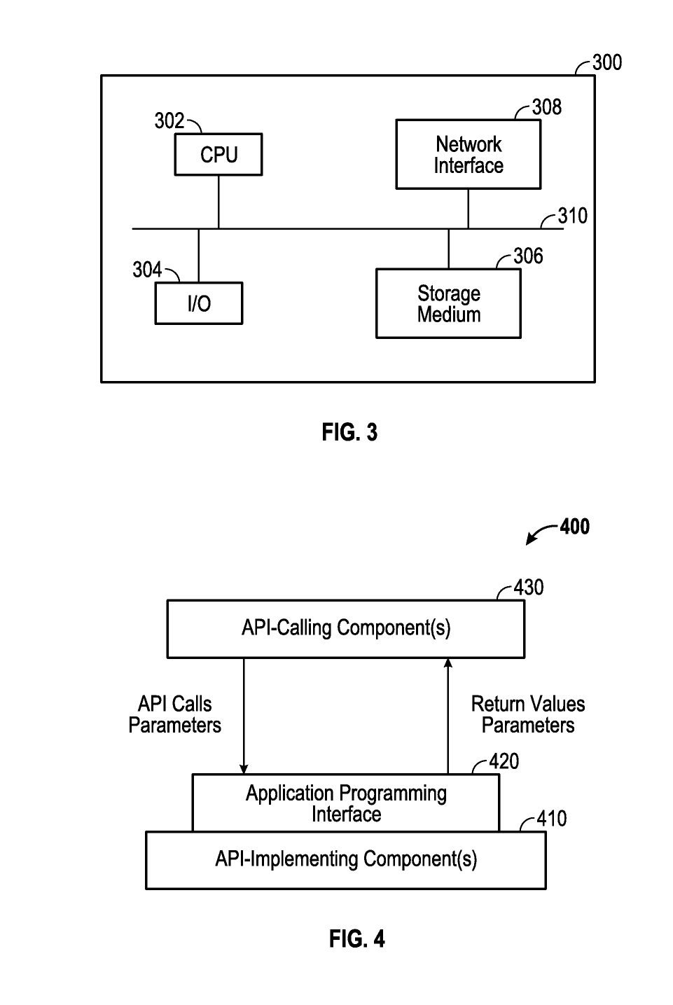

The non-transitory computer readable storage medium can be part of a computing system serving as a terminal or device of one of the embodiments of the disclosure. FIG. 3 illustrates exemplary common components of one such computing system. As illustrated, the system 300 can include a central processing unit (CPU) 302, I/O components 304 including, but not limited to one or more of display, keypad, touch screen, speaker, and microphone, storage medium 306 such as the ones listed in the last paragraph, and network interface 308, all of which can be connected to each other via a system bus 310. The storage medium 306 can include the modules of FIG. 2.

One or more APIs may be used in some embodiments. An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

An API allows a developer of an API-calling component (which may be a third party developer) to leverage specified features provided by an API-implementing component. There may be one API-calling component or there may be more than one such component. An API can be a source code interface that a computer system or program library provides in order to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

An API defines the language and parameters that API-calling components use when accessing and using specified features of the API-implementing component. For example, an API-calling component accesses the specified features of the API-implementing component through one or more API calls or invocations (embodied for example by function or method calls) exposed by the API and passes data and control information using parameters via the API calls or invocations. The API-implementing component may return a value through the API in response to an API call from an API-calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API-calling component) and an API-implementing component. Transferring the API calls may include issuing, initiating, invoking, calling, receiving, returning, or responding to the function calls or messages; in other words, transferring can describe actions by either of the API-calling component or the API-implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API-implementing component. Thus, the API-calling component may declare variables, use pointers to, use or instantiate constant values of such types or classes by using definitions provided in the API.

Generally, an API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic. In some embodiments, an API may allow a client program to use the services provided by a Software Development Kit (SDK) library. In other embodiments an application or other client program may use an API provided by an Application Framework. In these embodiments the application or client program may incorporate calls to functions or methods provided by the SDK and provided by the API or use data types or objects defined in the SDK and provided by the API. An Application Framework may in these embodiments provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API-calling component may be a local component (i.e., on the same data processing system as the API-implementing component) or a remote component (i.e., on a different data processing system from the API-implementing component) that communicates with the API-implementing component through the API over a network. It should be understood that an API-implementing component may also act as an API-calling component (i.e., it may make API calls to an API exposed by a different API-implementing component) and an API-calling component may also act as an API-implementing component by implementing an API that is exposed to a different API-calling component.

The API may allow multiple API-calling components written in different programming languages to communicate with the API-implementing component (thus the API may include features for translating calls and returns between the API-implementing component and the API-calling component); however the API may be implemented in terms of a specific programming language. An API-calling component can, in one embedment, call APIs from different providers such as a set of APIs from an OS provider and another set of APIs from a plug-in provider and another set of APIs from another provider (e.g. the provider of a software library) or creator of the another set of APIs.

FIG. 4 is a block diagram illustrating an exemplary API architecture, which may be used in some embodiments of the invention. As shown in FIG. 4, the API architecture 400 includes the API-implementing component 410 (e.g., an operating system, a library, a device driver, an API, an application program, software or other module) that implements the API 420. The API 420 specifies one or more functions, methods, classes, objects, protocols, data structures, formats and/or other features of the API-implementing component that may be used by the API-calling component 430. The API 420 can specify at least one calling convention that specifies how a function in the API-implementing component receives parameters from the API-calling component and how the function returns a result to the API-calling component. The API-calling component 430 (e.g., an operating system, a library, a device driver, an API, an application program, software or other module), makes API calls through the API 420 to access and use the features of the API-implementing component 410 that are specified by the API 420. The API-implementing component 410 may return a value through the API 420 to the API-calling component 430 in response to an API call.

It will be appreciated that the API-implementing component 410 may include additional functions, methods, classes, data structures, and/or other features that are not specified through the API 420 and are not available to the API-calling component 430. It should be understood that the API-calling component 430 may be on the same system as the API-implementing component 410 or may be located remotely and accesses the API-implementing component 410 using the API 420 over a network. While FIG. 4 illustrates a single API-calling component 430 interacting with the API 420, it should be understood that other API-calling components, which may be written in different languages (or the same language) than the API-calling component 430, may use the API 420.

The API-implementing component 410, the API 420, and the API-calling component 430 may be stored in a machine-readable medium described above.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A method of operating a terminal device, comprising:
obtaining a current load occupancy parameter of the terminal device, and
adjusting a working parameter of a processing unit of the terminal device in accordance with the current load occupancy parameter of the terminal device.

2. The method of claim 1, wherein obtaining the current load occupancy parameter of the terminal device comprises:
obtaining, in accordance with an operating mode of the terminal device, a load occupancy parameter corresponding to the operating mode in accordance with a set correspondence between operating modes and load occupancy parameters, or
obtaining, in accordance with a usage activity associated with the terminal device, a load occupancy parameter corresponding to the usage activity in accordance with the set correspondence between usage activities and load occupancy parameters.

3. The method of claim 2, wherein obtaining, in accordance with the operating mode of the terminal device, the load occupancy parameter corresponding to the operating mode in accordance with the set correspondence between operating modes and load occupancy parameters comprises one of:
when the operating mode comprises a game mode, obtaining a first load occupancy parameter corresponding to a game mode in accordance with the set correspondence between the operating modes and the load occupancy parameters,
when the operating mode comprises a reading mode, obtaining a second load occupancy parameter corresponding to the reading mode in accordance with the set correspondence between the operating modes and the load occupancy parameters, and
when the operating mode comprises a sleep mode, obtaining a third load occupancy parameter corresponding to the sleep mode in accordance with the set correspondence between the operating modes and the load occupancy parameters,
wherein, the first load occupancy parameter is higher than the second load occupancy parameter, which is higher than the third load occupancy parameter.

4. The method of claim 2, wherein adjusting a working parameter of a processing unit of the terminal device in accordance with the current load occupancy parameter of the terminal device comprises:
when the usage activity comprises running a game on the terminal device, obtaining a fourth load occupancy parameter corresponding to game running in accordance with the set correspondence between usage activities and load occupancy parameters,
when the usage activity comprises webpage browsing, obtaining a fifth load occupancy parameter corresponding to the webpage browsing in accordance with the set correspondence between usage activities and load occupancy parameters,
when the usage activity comprises screen-locking, obtaining a sixth load occupancy parameter corresponding to screen locking in accordance with the set correspondence between usage activities and load occupancy parameters, and
when the usage activity comprises power charging, obtaining a seventh load occupancy parameter corresponding to power charging in accordance with the set correspondence between usage activities and load occupancy parameters,
wherein the fourth load occupancy parameter is higher than the fifth load occupancy parameter, the sixth load occupancy parameter, and the seventh load occupancy parameter.

5. The method of claim 1, wherein adjusting a working parameter of a processing unit of the terminal device in accordance with the current load occupancy parameter of the terminal device comprises:
when the current load occupancy parameter of the terminal device is within a first range of values, setting the working parameter of the terminal device's processing unit to be a first frequency or first voltage,
when the current load occupancy parameter of the terminal device is within a second range of values, setting the working parameter of the terminal device's processing unit to be a second frequency or second voltage, and
when the current load occupancy parameter of the terminal device is within a third range of values, setting the working parameter of the terminal device's processing unit to be a third frequency or third voltage,
wherein the values in the first range of values can be lower than those in the second range of values, and the values in the second range can be lower than those in the third range.

6. The method of claim 1, wherein the processing unit comprises either a central processing unit or a graphic processing unit.

7. A terminal device comprising:
a load occupancy parameter obtaining module that obtains the terminal device's current load occupancy parameter, and
an adjusting module that adjusts a working parameter of the terminal device's processing unit according to the current load occupancy parameter of the terminal device.

8. The terminal device of claim 7, wherein the load occupancy parameter obtaining module obtains, according to the terminal device's operating mode, a load occupancy parameter corresponding to the operating mode in accordance with a set correspondence between operating modes and load occupancy parameters, or
the load occupancy parameter obtaining module obtains, according to the usage activity associated with the terminal device, a load occupancy parameter corresponding to the usage activity in accordance with a set correspondence between usage activities and load occupancy parameters.

9. The terminal device of claim 8, wherein the load occupancy parameter obtaining module:
when the operating mode comprises a game mode, obtains a first load occupancy parameter corresponding to the game mode in accordance with the set correspondence between operating modes and load occupancy parameters,
when the operating mode comprises a reading mode, obtains a second load occupancy parameter corresponding to the reading mode in accordance with the set correspondence between operating modes and load occupancy parameters, and
when the operating mode comprises a sleep mode, obtains a third load occupancy parameter corresponding to the sleep mode in accordance with the set correspondence between operating modes and load occupancy parameters,
wherein the first load occupancy parameter is higher than the second load occupancy parameter, and the second load occupancy parameter is higher than the third load occupancy parameter.

10. The terminal device of claim 8, wherein the load occupancy parameter obtaining module:
when the usage activity comprises running a game on the terminal device, obtains a fourth load occupancy parameter corresponding to game running in accordance with the set correspondence between usage activities and load occupancy parameters,
when the usage activity comprises webpage browsing, obtains a fifth load occupancy parameter corresponding to webpage browsing in accordance with the set correspondence between usage activities and load occupancy parameters,
when the usage activity comprises screen locking, obtains a sixth load occupancy parameter corresponding to screen locking in accordance with the set correspondence between usage activities and load occupancy parameters,
when the usage activity comprises power charging, obtains a seventh load occupancy parameter corresponding to power charging in accordance with the set correspondence between usage activities and load occupancy parameters,
wherein the fourth load occupancy parameter is higher than the fifth load occupancy parameter, sixth load occupancy parameter, and seventh load occupancy parameter.

11. The terminal device of claim 7, wherein the adjusting module:
when the current load occupancy parameter of the terminal device is within a first range of values, adjusting a working parameter of the terminal device's processing unit to be a first frequency or first voltage,
when the current load occupancy parameter of the terminal device is within a second range of values, adjusting a working parameter of the terminal device's processing unit to be a second frequency or second voltage, and
when the current load occupancy parameter of the terminal device is within a third range of values, adjusting the working parameter of the terminal device's processing unit to be a third frequency or third voltage,
wherein the values in the first range of values is lower than those in the second, and the values in the second range of values is lower than those in the third,
the first frequency is lower than the second frequency, and the second frequency is lower than the third frequency, and
the first voltage is lower than the second voltage, and the second voltage is lower than the third voltage.

12. The terminal device of claim 7, wherein the process unit comprises either a central processing unit or a graphic processing unit.

13. A method of managing power usage of a terminal device, comprising:
predetermining a correspondence between load occupancy parameters and various states of the terminal device,
detecting a current state of the terminal device,
determining the load occupancy parameter corresponding to the current state of the terminal device in accordance with the predetermined correspondence, and
setting a level of power output in accordance with the determined load occupancy parameter.

14. The method of claim 13, wherein the current state of the terminal device comprises either an operating mode of the terminal device or a usage activity associated with the terminal device.

15. The method of claim 14, wherein the operating mode comprises one of a game mode, reading mode, and sleep mode.

16. The method of claim 14, wherein the usage activity comprises one of running a game, webpage browsing, screen-locking, and power charging.

17. The method of claim 13, wherein setting the level of power output in accordance with the determined load occupancy parameter comprises adjusting a working parameter of the terminal device's processing unit.

18. The method of claim 17, wherein adjusting a working parameter of the terminal device's processing unit comprises adjusting at least one of a frequency and a voltage associated with the processing unit.

19. The method of claim 13, wherein detecting a current state of the terminal device is in response to a user input.

20. The method of claim 19, wherein the user input comprises a single-key input.
